(19) United States
(12) Patent Application Publication
(10) Pub. No.: US 2026/0295924 A1
(43) Pub. Date: Oct. 1, 2026

(54) Stretching Device and Method for Uniaxially Stretching a Film Web in the Transport Direction Thereof

(71) Applicant: Windmöller & Hölscher KG, Lengerich (DE)

(72) Inventors: Ingo Rübbelke, Lengerich (DE); Fabian Fischer, Lengerich (DE); Marc Münnich, Lengerich (DE); Daniel Thiemann, Lengerich (DE)

(21) Appl. No.: 19/475,914

(22) PCT Filed: May 15, 2024
(86) PCT No.: PCT/EP2024/063341

§ 371 Date: Oct. 28, 2025

(30) Foreign Application Priority Data
May 17, 2023 (DE) 10 2023 204 668.7

(51) Int. Cl. B29C 55/06; B29K 105/00

(52) U.S. Cl. CPC B29C 55/06; B29K 2105/256

(57) ABSTRACT

The invention relates to a stretching device for uniaxially stretching a film web in the transport direction thereof, the stretching device comprising: a first roll (holding roll), via which the film web can be run and which rotates at a first circumferential speed; a second roll (stretching roll), which is arranged downstream of the first roll and via which the film web can be run and which rotates at a second circumferential speed; wherein the second circumferential speed is greater than the first circumferential speed; wherein at least one clamping roll is provided, by means of which the film web can be pressed against one of the rolls. At least one holding arrangement is provided relative to which the clamping roll can be rotated about its rotational axis. The clamping roll is supported on the holding assembly by a support point extending over part of, in particular over more than a quarter of, the axial length of the clamping roll, or by a plurality of support points distributed over the axial length of the clamping roll and/or the circumference of the clamping roll. A first movement device is provided by means of which the one or more support points can be or are moved relative to the clamping roll in a direction parallel to the rotational axis of the clamping roll.

The invention relates to a stretching device for uniaxial stretching of a film web in its transport direction according to claim 1 and to a method according to claim 9.

A generic stretching device, which is often arranged inline, in particular in or downstream of a blown film line or a flat film line, comprises at least one first roll, which can also be referred to as a holding roll, over which the film web can be guided and which rotates at a first circumferential speed. Downstream of the first roll is a second roll, which can also be referred to as a stretching roll and over which the film web can be guided after it has left the first roll. The second roll rotates at a second circumferential speed, this second circumferential speed being greater than the first circumferential speed. In the section in which the film web has already left the first roll and has not yet reached the second roll, the film is stretched in its transport direction. This section is often referred to as the stretching gap. In addition, the first and second rolls usually rotate in opposite directions so that the film web is guided over each of the two rolls with the largest possible wrap angle. Overall, the described stretching process specifically changes important properties of the film web.

However, this stretching also causes the undesirable phenomenon of neck-in, in which the film web becomes narrower than its original width. In addition, the edges of the film web thicken, resulting in an uneven thickness profile in the transverse direction. The edges must therefore be cut off so that the usable width of the film web is reduced. The cut edges cannot be used and therefore cause undesirable costs. To reduce these effects, many improvements have been proposed in the past. One measure is the provision of at least one clamping roll with which the film web can be pressed against one of the rolls. Reducing the stretching gap has also led to improvements in the past.

However, if a clamping roll is used, the stretching gap cannot be reduced to the desired extent with conventional stretching devices. The as yet unpublished patent application PCT/EP2022/081608 shows clamping rolls with a reduced diameter that are supported by support points in order to reduce deflection. This measure made it possible to reduce the stretching gap, resulting in a larger usable portion of the film web. However, as the support points have interruptions, there is a risk that these interruptions will always appear as defects at the same points on the film web when viewed in the transverse direction, which can lead to poor quality of the film web.

The task is therefore to propose a stretching device and a method with which the above-mentioned disadvantages can be reduced.

The above task is solved by a stretching device having the features of claim 1 and a method having the features of claim 9. Further features and details of the invention are apparent from the subclaims, the description and the drawings. Features and details which are described in connection with the method according to the invention naturally also apply in connection with the stretching device according to the invention and vice versa, so that reference is or can always be made to the individual aspects of the invention with respect to the disclosure.

The stretching device according to the invention is characterized in that
at least one holding arrangement is provided, relative to which the clamping roll can be rotated about its rotational axis,
the clamping roll is supported on the holding arrangement via a support point extending over a part, in particular over more than a quarter, of the axial length of the clamping roll or via a plurality of support points distributed over the axial length of the clamping roll and/or the circumference of the clamping roll, and
a first movement device is provided, with which the support point or the support points is or are movable relative to the clamping roll in a direction parallel to the rotational axis of the clamping roll.

In particular, the invention is based on the realization that the support points, in particular the support rollers, reduce the deflection of the clamping roll, but are always in contact with the same points of the clamping roll. Since a clamping roll usually has an elastic circumferential surface, the areas where the support points are in contact are pressed in more than other areas. By the time the pressed-in areas have reached the film web, the pressed-in areas have often not reset, which leads to uneven pressure from the clamping roll on the film web. The pressed-in areas can also be pressed in more and more, which increases the effect described. Furthermore, different levels of soiling can occur depending on whether or not surface areas of the clamping roll are contacted by the support points.

The contact points between the clamping roll and the support point can be changed by moving the support points relative to the clamping roll. In particular, this can be done periodically. The advantage of this is that the aforementioned effects no longer occur at the same points and are not transferred to the same points on the film web. Since ever-increasing indentations of the clamping roll are also avoided, the overall quality of the film web is improved.

Furthermore, according to the invention, a holding arrangement is provided, relative to which the clamping roll can be rotated, wherein the clamping roll is supported on the holding arrangement via a support point extending over a part, in particular over more than a quarter, of the axial length of the clamping roll or several support points distributed over the axial length of the clamping roll and/or the circumference of the clamping roll.

With these measures, it is possible to intercept the forces acting on the clamping roll by means of a holding arrangement that is further away from the first and/or second roll when viewed in the radial direction. The space available here can now be used to design the holding arrangement with a high bending stiffness. This leads to a more uniform thickness of the film web and thus to improved quality.

Conversely or additionally, it is possible to reduce the diameter of the clamping roll compared to the state of the art. A reduced diameter of the clamping roll means that the stretching gap is or can be reduced and the clamping roll is still positioned at the peel line or the impact line. A reduced stretching gap is advantageous, as this further reduces the neck-in effect. It can be advantageous if several clamping rolls are assigned to at least one of the rolls.

Furthermore, the invention also makes it possible for the film web to run over the clamping roll with a wrap angle. The force exerted by the film web on the clamping roll in this case can be readily compensated by the construction according to the invention, while at the same time any streaking on the film web is avoided. It is advantageous if the film web wraps around the clamping roll with a wrap angle between 0° and 90°. In particular, the wrap angle is between 0.1° and 90°, preferably between 0.5° and 90°. With the aforementioned measure, the stretching gap can be further reduced to reduce the neck-in.

In an advantageous embodiment of the invention, it is provided that the holding arrangement comprises at least one support which extends parallel to the rotational axis and is arranged immovably relative to the first and/or second roll. In particular, this support extends the entire length of the clamping roll and thus provides the counterforce required to compensate for the deflection of the clamping roll. This carrier therefore provides the required support force for the support points and thus for the clamping roll. The support can be designed as a single piece, but can also be made up of individual support pieces. This enables a modular design of the carrier, in which the carrier can be assembled from a different number of carrier pieces depending on the working width of the stretching device, which in particular reduces the manufacturing costs of the stretching device. Regardless of the design of the carrier, it must be designed in such a way that the force acting on the clamping roll does not lead to deflection of the carrier. The carrier and the roll to which this carrier is assigned are preferably arranged so that they cannot move relative to each other. This means that when the roll is adjusted, the associated support is also adjusted, so that the forces acting on the clamping roll are not displaced.

In order to bring about simple displaceability of the support points relative to the clamping roll, it is advantageously provided that the first movement device comprises a frame on which each support point is supported, the frame being movable relative to the clamping roll and in particular relative to the carrier. This makes it possible to provide a simple displacement drive which acts on the frame. In particular, this creates a stable device that enables displacement but has only a minor effect on the forces acting on the clamping roll.

In a further embodiment, it is provided that the frame is supported on the carrier and, in particular, can be displaced relative to it by means of sliding or rolling devices. A sliding device can be a rail-slide combination, which results in a cost-effective design. A roller device can be a roller track, for example, with a large number of rollers arranged on the carrier or on the frame. With a roller conveyor, the friction between the carrier and the frame can be minimized.

It is advantageous if the first movement device comprises at least one drive device with which each support point and/or in particular the frame can be moved alternately in a first direction and in a second direction opposite to the first direction. This drive device can, for example, be a linear motor or a servomotor. A drive designed as a double-acting piston-cylinder unit is also conceivable. Alternatively, a rotating drive can be provided whose rotational movement can be converted into a linear movement via gear elements. A drive device can be used to set the support elements into a periodic movement in particular. It is particularly advantageous if the amplitude of the movement can be adjusted. It is particularly advantageous if the movement in the first and second directions is greater than 0 mm in each case and is less than 300 mm, in particular less than 200 mm.

It is particularly advantageous if a first row and at least one second row of support points are provided, wherein the rows extend in the longitudinal direction of the clamping roll, wherein in particular the first and second rows are displaceable relative to one another. This makes it possible to carry out the movements of the individual rows independently of one another. In this case, it may be necessary to provide a separate drive for each row or, if a single drive is provided, to enable relative displaceability of the two rows via a coupling. In particular, it may be provided that the displacement movement of the two rows can be adjusted relative to each other and, in particular, can be adjusted independently of each other. This makes it possible to provide the best possible adjustability of the operating parameters, even with different film webs, in order to achieve the best possible quality of the film web. It is also advantageous if the support points of each row are arranged in a separate frame, again to enable a simple structure. Each frame can be moved relative to the carrier, as described above in connection with a single frame.

In this context, it is advantageous if at least two rows of support points or at least two support points are provided, which are each arranged at different angular positions in the circumferential direction of the clamping roll. In this way, the clamping roll runs in a channel-like depression, which can also be referred to as a roll bed. The clamping roll is thus supported at different points so that the clamping force provided by the holding arrangement is better distributed over the outer circumference of the clamping roll. This measure also makes it easier to hold the clamping roll in position.

In order to reduce the disadvantages described above even further, a second movement device is provided with which the clamping roll is movable in its axial direction. The clamping roll can thus be movable relative to the first or second roll in order to further equalize the force acting on the film web, which in turn can lead to an improved quality of the film web. The second movement device can comprise a second drive, which is arranged on the holding arrangement. A double-acting and compressed air-operated piston cylinder unit is a suitable second drive for the second movement device. A permanently rotating motor is also conceivable, the rotational movement of which is converted into a linear movement via a wheel and a coupling rod, for example. Finally, a servomotor or a linear motor is also conceivable.

In order to enable such a displacement of the clamping roll, it is provided that the clamping roll is connected to the holding arrangement via at least one holder or via at least one attachment piece, whereby in particular the clamping roll is movable relative to the holder or attachment piece with the second movement device or the holder or attachment piece together with the clamping roll is movable relative to the holding arrangement. It is therefore possible to move the holder(s) or attachment piece relative to the holding arrangement, in particular relative to its support, whereby the clamping roll can also be moved. Instead or in addition, the clamping roll can also be displaceably mounted relative to the holder or attachment piece, for example in slide bearings.

It is advantageously provided for each clamping roll to be rotatably mounted at its ends in holders or attachment pieces of the holding arrangement, whereby in particular provision is also made for the clamping rolls to be displaceable relative to the holders or attachment pieces in the radial direction of the clamping roll.

Preferably, a holding arrangement is assigned to each clamping roll.

The holding arrangement is preferably supported on the machine frame in which the first and/or the second roll is also supported.

In an advantageous embodiment of the invention, the at least one support point comprises at least one roller (also referred to as a support roller), on the circumferential surface of which the clamping roll rolls. In particular, each support point comprises several rollers. The roller is in turn supported on the holding arrangement. Such a roller reduces the friction of the pressure roller so that its surface remains as undamaged as possible.

In a further development, it is provided that the at least one support point comprises at least one support roller, which is mounted on an axle via at least one bearing, the axle being attached to the holding arrangement, in particular to a displaceable frame of the holding arrangement, by means of an axle carrier or holder. In particular, it is intended that the roller is rotatably supported on the axle via ball, roller or needle bearings. Such bearings can withstand large forces, which are necessary for supporting a clamping roll in a stretching device. In particular, each axle is attached to the holding arrangement at both ends by means of an axle carrier. An axle carrier can be a common axle carrier for two adjacent axles. Furthermore, axle carriers can be distributed over the axial length of an axle. A separate axle can be provided for each roller, but it is advantageous to provide at least two rollers on each axle. Instead of a plurality of rollers, elongated rollers whose axial length is greater than their outer diameter can also be provided.

Alternatively or additionally, it is advantageous if the at least one support point comprises at least one roller, each roller being attached to a shaft, the shaft being rotatably mounted on a shaft bearing, which in turn is attached to a frame of the holding arrangement. The embodiments described above in relation to the axles can also be applied mutatis mutandis to the shaft arrangement.

The rollers disclosed in the aforementioned embodiments can be provided in various configurations. For example, to reduce the friction between a roller and a clamping roll, it may be provided to provide the roller with a smooth circumferential surface, i.e. the surface on which the clamping roll rolls. This can be achieved, for example, by chrome-plating the roller surface. In this context, it can be advantageous to avoid damage if the circumferential surface is hard or rigid, which can be achieved in particular by a circumferential surface comprising a metal. A hard or rigid circumferential surface and/or a smooth circumferential surface are particularly advantageous if the clamping roll comprises a soft circumferential surface. This ensures that the clamping roll does not suffer excessive wear or even damage, even in the event of relative movement between the clamping roll and the support elements.

It may further be provided that the circumferential surface of at least one roller comprises a structure. A structure means that there are indentations on the circumferential surface. Such a structure may be regular, for example comprising grooves and/or holes. Such a regular structure is therefore created in particular by machining or manufacturing the circumferential surface with a tool, in particular by contact machining. Additionally or alternatively, irregular structuring of the circumferential surface of the at least one roller may be provided. Such irregular structuring can be achieved in particular by projectile blasting of the circumferential surface, as is the case with sandblasting or glass bead blasting. A structure with indentations serves primarily to absorb the air introduced into the roll/roller gap by the clamping roll, thereby preventing contact breakage between the roll and the clamping roll.

In general, the circumferential surface condition can be made dependent on that of the roll, i.e. the holding roll and/or the stretching roll. If the roll comprises a flexible circumferential surface, in particular due to an at least partially elastomeric coating, an associated clamping roll can comprise a very hard circumferential surface, for example if this comprises a polished steel. In this case, it is preferred that the support roller comprises at least partially a flexible circumferential surface.

The at least one roller can be concave on its circumferential surface, i.e. it has a larger diameter at its edges in the direction of its axis of rotation than in the center. Alternatively, the circumferential surface can be convex. A concave or convex circumferential surface can reduce the contact area between the clamping roll and the roller and thus the surface wear. However, a convex shape is particularly advantageous, so that the displaceability of the roller relative to the clamping roll is improved.

In the context of the present invention, a roller is also to be understood as a sleeve in which, in particular, the axial length is greater than the diameter.

In a further advantageous embodiment of the invention, the support point comprises at least one concavely shaped channel element in which the clamping roll lies, wherein the inner surface of the channel element is provided with openings through which a fluid under excess pressure can be conducted into the region between the channel element and the clamping roll. This fluid is preferably a gas, in particular air. With this measure, the clamping roll can therefore be held by the support point without contact and guided during rotation. This results in a “floating bearing” of the clamping roll. The channel element can be an elongated shell made of a plastic, a fiber-reinforced plastic or a metal. The openings on the inner surface, the radius of which is preferably only slightly larger than the outer radius of the clamping roll, can be connected to supply lines, such as through-holes, so that the pressurized fluid (higher pressure than the ambient pressure) can be easily supplied from the outside. In order to achieve better distribution of the fluid between the inner surface and the outer surface of the clamping roll, the inner surface of the channel element can be covered or coated with a fine-pored material, such as sintered plastic and/or sintered metal. It is also possible to form the channel element exclusively with a sintered material.

In order to apply a force to the clamping roll against the at least one support point, at least one tensioning device is provided, with which a force can be provided, with which the clamping roll can be acted upon and which acts in the direction of the holding arrangement and in particular in the radial direction of the clamping roll. Even if end-side holders are provided for the clamping roll, as described above, such a tensioning device is advantageous in order to hold the clamping roll over its entire length at or in the at least one support point. This is particularly important when the clamping roll, which is not yet rotating, is brought into contact with the first and/or second roll, which is already rotating, or with the film web. The tensioning device now prevents the clamping roll from jumping out of the support point or jamming with the support point.

It is particularly advantageous if at least one pulling device is provided, with which a force directed in the direction of the holding arrangement can act on the clamping roll, the pulling device comprising at least one magnet and at least one magnetizable element. The magnet is arranged in or on the holding arrangement and the magnetizable element is arranged in or on the clamping roll and/or in or on the holding arrangement. In other words, in order to generate an attractive magnetic force, one element must be partially magnetizable and the second element must carry at least one magnet. The magnet is preferably a permanent magnet, but can also be a switchable electromagnet.

Alternatively or additionally, it is advantageous if at least one pulling device is provided, with which a force directed in the direction of the holding arrangement can act on the clamping roll, wherein the pulling device comprises at least one suction device arranged on the holding arrangement, with which a suction force acting in the direction of the holding arrangement can be applied to the clamping roll. A suction device can, for example, be a bore, a hose, a tube or similar, one end of which is located in the direct vicinity of the clamping roll and the other end of which is connected to a vacuum generator, such as a blower or a vacuum pump. The advantage of using such a suction device to generate the tensile force is that the magnitude of the tensile force can be varied.

Furthermore, it is advantageous if at least one cleaning element is arranged on the holding arrangement, in particular on the support of the holding arrangement, with which the outer surface of the clamping roll can be cleaned. Such a cleaning element can, for example, be a cloth, felt piece or similar extending at least partially over the length of the clamping roll, which in particular permanently contacts the clamping roll. However, the cleaning element can also be a cleaning element that is attached to a carriage. This carriage is movable along a guide, which is preferably attached to the carrier, in the axial direction of the clamping roll. This allows the surface of the clamping roll to be cleaned by moving the carriage continuously or as required. The carriage can also be moved beyond at least one end of the clamping roll in order to be able to change or clean the cleaning element itself. Cleaning the clamping roll again has the advantage that no deposits or soiling build up that could damage the film web.

Furthermore, it is preferred if the clamping roll is provided with a coating, in particular a rubber coating, on its outer surface. The coating is advantageously made of a compressible material so that the film web experiences sufficient static friction.

It is also advantageous if the clamping roll can be driven in rotation by a drive. In other words, a drive is provided with which the clamping roll can be set in rotation or stopped. This drive can be a known electric motor or an air motor. The advantage is that the clamping roll can already be set in rotation before it is placed on an already moving film web. On the one hand, this reduces wear on the clamping roll and, on the other hand, damage to the film web is avoided when the clamping roll is positioned.

It is also advantageous if the clamping roll can be pressed against the roll in an angular range which is at most+1-30 degrees around the line on the roll, which is defined by the common tangential plane of both rolls. For this purpose, it is provided to mount the holding arrangement movably relative to the roll, wherein the holding arrangement is movable at least in the circumferential direction of the at least one roll. In particular, it is advantageous if the clamping roll is movable beyond the said line when viewed in the transport direction of the foil web. In this case, the film web does not leave or touch the roll at the detachment line or the impact lines, but rather afterwards or before. Specifically, this means that in the case of the holding roll, the film web first runs on the clamping roll and in the case of the stretching roll, it first runs on the clamping roll before it hits the stretching roll. In this case, the stretching gap can be shortened again so that the neck-in is further reduced.

In a further embodiment of the invention, it is provided that at least two holding arrangements are provided for the holding roll and/or for the stretching roll, the two holding arrangements being connected to one another via connecting elements. A total of two holding arrangements can thus be provided per roll, the two holding arrangements being attached to a connecting element. The dimensions of the connecting element are such that the clamping roll of the first holding arrangement presses the film web against the roll in the area of its contact line and that the clamping roll of the second holding arrangement presses the film web against the roll in the area of the release line. The connecting element can be movable relative to the relevant roll in the circumferential direction and/or in the radial direction by means of at least one adjusting mechanism, so that the clamping rolls are also movable with the movement of the connecting element. To move the connecting element, the actuating element preferably comprises at least one air-operated piston-cylinder unit. Preferably, the connecting element is supported on the machine frame on which the relevant roll is also supported. If two holding arrangements, which are connected to each other via a connecting element, can be positioned on different lines of the roll in question, this results in an increased actuating force, as the connecting element, which is particularly rigid, also contributes to a normal force in the radial direction of the roll. Overall, the film web is thus pressed even more strongly against the roll for a given contact force, so that the neck-in can be further reduced. It is particularly preferable if two holding arrangements and one connecting element each are assigned to both the holding roll and the stretching roll.

The stretching device described above and the advantageous embodiments can be provided within any film production or film processing line. In particular, the stretching device according to the invention can be provided inline within a blown film line or a flat film line. In a blown film line, for example, the stretching device can be provided in the transport direction of the film web between a flattening device and a reversing device or downstream of the reversing device, but upstream of a winding device. In a blown film line, the film web can also be a two-layer film web that has been laid together from a film bubble. The two layers of the film web can then be joined together at both side edges or only at one side edge, or separated from each other by prior cutting on both sides.

The above-mentioned task is additionally solved by a method for uniaxial stretching of a film web in its transport direction, wherein the film web is guided over a first roll (holding roll) which rotates at a first circumferential speed,
wherein the film web is guided over a second roll (stretching roll) which is arranged downstream of the first roll and which rotates at a second circumferential speed,
wherein the second circumferential speed is greater than the first circumferential speed,
wherein the film web is pressed against one of the rolls by at least one clamping roll.

The method according to the invention is characterized in that at least one holding arrangement is provided, relative to which the clamping roll rotates, the clamping roll being supported on the holding arrangement via a support point extending over more than a quarter of the axial length or via a plurality of support points distributed over the axial length of the clamping roll and/or the circumference of the clamping roll, the support point or the support points being moved relative to the clamping roll in a direction parallel to the rotational axis of the clamping roll by means of a first movement device.

In this way, the same advantages can be achieved that have already been described above in connection with the stretching device according to the invention.

In one embodiment of the method according to the invention, it is provided that the clamping roll is also moved in the direction of its rotational axis. The movements of the support point and/or the clamping roll can be periodic. In particular, it is provided that the directions of movement of the clamping roll and the support points are in opposite directions. It may be provided that the speed profiles of the movements of the clamping roll and the support points are the same. However, different speed profiles can also be provided, in particular in connection with different distances traveled by the clamping roll and the support points. The aforementioned measures make it possible to adapt the movements to the properties of the film web. The movements can also be adapted to the process and operating parameters of a manufacturing device for the film web, in particular if the stretching device according to the invention is arranged inline.

Further advantages, features and details of the invention are apparent from the following description, in which various embodiments are explained in detail with reference to the figures. The features mentioned in the claims and in the description may be essential to the invention individually or in any combination of the features mentioned. In the context of the entire disclosure, features and details which are described in connection with the method according to the invention naturally also apply in connection with the stretching device according to the invention and vice versa, so that reference is or can always be made reciprocally to the individual aspects of the invention with regard to the disclosure. The individual figures show:

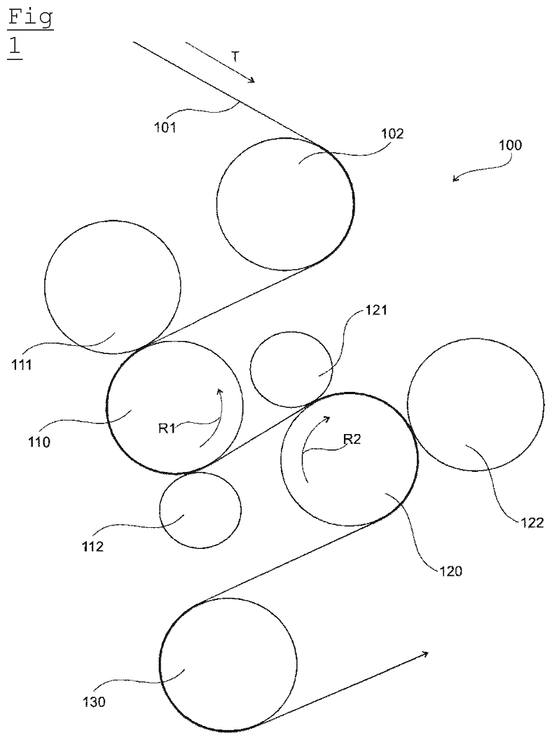

FIG. 1 Schematic representation of a stretching device according to the invention

FIG. 2 Illustration of further details of the stretching device according to the invention

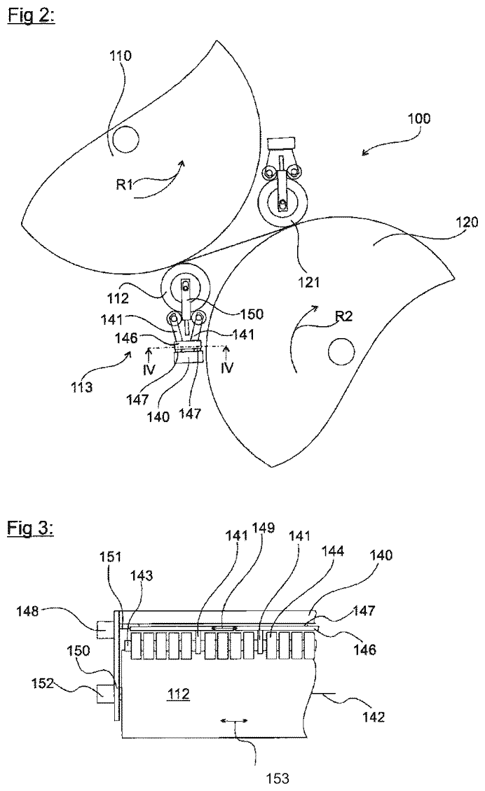

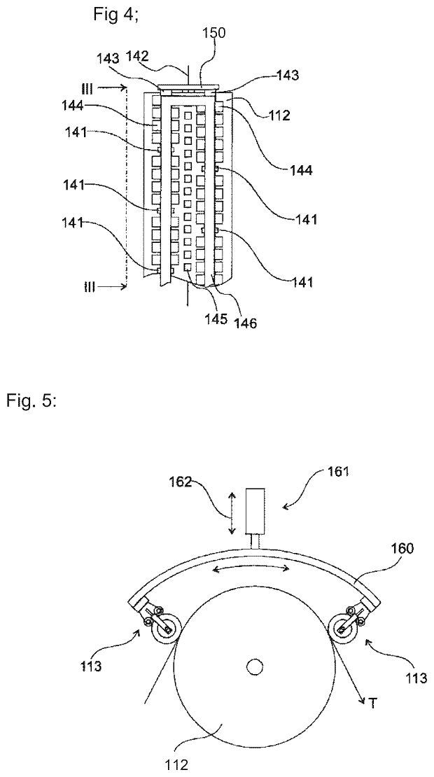

FIG. 3 View III-III from FIG. 4

FIG. 4 View IV-IV from FIG. 2

FIG. 5 Illustration of a further development of a stretching device according to the invention.

FIG. 1 shows a schematic representation of a stretching device according to the invention. The film web 101 runs into the stretching device 100 in the transport direction T. The film web first runs onto one or successively onto several preheating rollers, of which only one preheating roller 102 is shown. A preheating roller has the task of bringing the film to a predefined temperature. For this purpose, a preheating roller is usually tempered, whereby a tempered fluid is often introduced into the preheating roller.

After leaving the preheating roll(s) 102, the film web 101 passes onto a first roll 110, which may generally also be referred to as a holding roll 110. This holding roll may be connected to a drive not shown, for example a dedicated electric motor which drives the roll 110 to rotate at a first circumferential speed. Additionally or alternatively, a braking device may be provided.

The first roll 110 is preferably associated with a first clamping roll 111 which, together with the first roll 110, provides an inlet gap for the film. Preferably, the inlet gap or the running path of the film web 101 is set up in such a way that the film web 101 runs in the inlet gap tangentially to the rolls 110, 111. The roller gap already serves to minimize the air between the holding roll 110 and the film.

A second clamping roll 112 is associated with the first roll 110, which forms an outlet gap with the roll 110. The second clamping roll 112 can be adjustable in the circumferential direction and/or in the radial direction of the first roll 110. The second clamping roll 112 serves to ensure that the film leaves the first roll 110 along a line that runs parallel to the axial direction of the first roll 110.

Viewed in the transport direction T of the film 101, a second roll 120 is arranged downstream, which can be referred to as stretching roll 120. The stretching roll 120 is connected to a further drive not shown, for example a separate electric motor, which drives the roll 120 to rotate at a second circumferential speed. The directions of rotation R1 of the roll 110 and R2 of the roll 120 are in opposite directions. This ensures that the film web has the largest possible wrap angle around each roll 110, 120. The second circumferential speed is greater than the first circumferential speed, with the stretching roll 120 thus having a greater circumferential speed than the holding roll 110. This results in the film 101 being stretched in its transport direction between the outlet gap of the first roll 110 and the inlet edge of the second roll 120 in the ratio of the circumferential speeds. The distance between the outlet gap and the inlet edge is often also referred to as the stretching gap.

It is possible for the first roll 110 and the second roll 120 to be movable relative to each other. This allows the stretching gap to be influenced. A change in the stretching gap can influence the properties of the film. It is preferable to have the smallest possible stretching gap, i.e. the shortest possible distance between the rolls 110 and 120, in which the film web is guided freely.

Preferably, a third clamping roll 121 is associated with the second roll 120, which together with the second roll 120 provides a second inlet gap for the film. Preferably, the inlet gap or the running path of the film 101 is arranged such that the film 101 runs in the inlet gap tangentially to the rolls 120, 121. The roll gap serves to minimize the air between the stretching roll 120 and the film, so that the friction between the film web and the roll 120 is minimized.

In the event that the stretching gap is to be set very small, the third feed roll 121 would collide with the roll 110, so that in this case the third feed roll would have to be swung away.

The second roll 120 is further optionally associated with a fourth clamping roll 122, which forms an outlet gap with the roll 120. The fourth clamping roll 122 can also be adjustable in the circumferential direction of the second roll 120. The fourth clamping roll 122 serves to ensure that the film leaves the second roll 120 along a line that runs parallel to the axial direction of the roll 120.

In principle, one or more feed rollers can also be dispensed with in a stretching device according to the invention. Nevertheless, there can be talk of an inlet gap or outlet gap. This is then to be understood as the line along which the film is applied to the holding or stretching roll or at which the film is released from the holding or stretching roll.

Further rolls, in particular with one or two clamping rolls each, may be provided, with two rolls arranged directly one after the other being driven in such a way that the roll arranged downstream in each case has a higher circumferential speed than the preceding roll.

Downstream of the rolls 110, 120, at least one cooling roll 130 is arranged, with which the film web 101 can be cooled again, so that the new molecular orientation within the film web resulting from the stretching solidifies.

FIG. 2 shows further details of the stretching device 100 according to the invention. In addition to the holding roll 110 and the stretching roll 120, the second clamping roll 112 and the third clamping roll 121 are shown. One embodiment of the invention is thereby explained in connection with the clamping roll 112, although further or all clamping rolls, in particular the clamping roll 121 may be in connection with an embodiment of the invention.

The second clamping roll 112 and/or the third clamping roll 121 are preferably supported on a carrier 140, in particular a cross carrier, which extends transversely to the transport direction of the film web. The carrier 140 in turn is supported directly or indirectly on the machine frame, on which the roll or rolls are also supported. The carrier 140 itself can consist of several individual pieces joined together. Since the roll 110 or the rolls 110, 120 can be movable relative to the machine frame, adjusting devices such as swivel bearings or slide-rail combinations can be provided between the machine frame and the rolls 110, 120. The carriers 140 can also be supported on these adjusting devices, whereby the carriers 140 and thus the clamping rolls can be separately movable relative to the adjusting devices in order to be able to move the clamping rolls relative to the first and/or the second roll 110, 120. The manner in which the clamping rolls are supported on the carriers is described below with reference to an embodiment example, although the invention is not limited to this embodiment example.

The further, preferred embodiment of a holding arrangement 113 for a clamping roll is now described by way of example for the clamping roll 112, but is of course valid for all other clamping rolls. FIGS. 3 and 4 show further views of the holding arrangement, to which reference is also made in the following description.

A plurality of holders 141 are connected to a frame 146, which are distributed over the longitudinal direction of the frame and thus over the axial direction of the clamping roll 112. The axial direction is represented by the representation of the axis of rotation 142 of the clamping roll. Each holder 141 carries an axle 143, whereby a separate axle 143 can be provided between each two holders 141 or an axle 143 can extend through several holders 141. Alternatively, shafts can be provided instead of axles, which are then rotatably mounted in the holders, so that the following description in relation to the axles 143 also applies to shafts. The axle 143 between two holders 141 is also referred to below as the axle section.

The frame 146 is in turn supported on the carrier 140, wherein rails 147 are preferably attached to the carrier 140, on which the frame can be displaceable mounted, in particular via sliding elements or carriages. The displaceability parallel to the axis 142 of the clamping roll 112 is shown by the double arrow 149. In order to enable a to-and-fro movement along the double arrow, a displacement drive 148 is provided, which is attached directly or indirectly to the carrier 140, for example. The displacement drive 148 is connected to the frame, for example, via a push rod 151. The components described in this paragraph, in particular the rails 147, the frame 146, the displacement drive 146 and/or the push rod 151, can be components of a movement device within the meaning of claim 1. Of these components, only the frame 146 can be seen in FIG. 4.

A first and at least a second axle 143 or a first and at least a second row of axles 143 are provided, which extend parallel to each other and parallel to the axial direction of the clamping roll 112. Each axle 143 carries one or more rollers 144, which are rotatably mounted on the axle. In the case of shafts, these rollers 144 may be fixedly connected to the shaft. Thus, together with the axles 143, the rollers 144 are also distributed over the clamping roll in the axial direction thereof. During operation, the clamping roll 112 rolls on these rollers 144, so that these are components of the supporting device via which the clamping roll 112 is supported on the holding arrangement 113. One group of rollers 144 can be provided for each axle 143 or axle section. It is advantageous if axle sections of the first axle or axle row are arranged offset in the axial direction relative to at least one axle section of the second axle or axle row, in order to avoid spot soiling or wear which would otherwise occur due to uneven rolling of the rollers on the clamping roll.

The two parallel axles or rows of axles together with their rollers 144 form a groove-like recess in which the clamping roll 112 lies, so that movement of any kind other than just the intended rotational and/or sliding movement is avoided. The clamping roll 112 itself can be rotatably mounted in the end face holders 141 or in attachment pieces 150 of these holders via a pivot bearing. The pivot bearing can be displaceable arranged in the holder or its attachment piece in order to reduce any radial forces on the pivot bearing in the event of varying contact pressure forces. This displaceability can be realized, for example, by means of slotted holes in the attachment pieces 150, in which the pivot bearings are displaceable arranged. In addition, a displacement drive 152 for the clamping roll 112 can be arranged on the attachment piece 150 so that it can be moved back and forth along its axis 142, i.e. in the direction of the double arrow 153.

In order to be able to keep the clamping roll always in contact with the rollers 144, several magnets 145 can be arranged directly or indirectly on the carrier in the axial direction over the length of the clamping roll 112. In this embodiment, the clamping roll comprises in its body at least one magnetizable element, preferably an iron core extending in the axial direction, which is attracted by the magnets, which are preferably permanent magnets, via a magnetic force. The magnetizable element within the clamping roll is not shown.

Overall, the arrangement described in connection with FIGS. 2 to 4 reduces the deflection of the clamping roll. This makes it possible, on the one hand, to increase the clamping force of the clamping roll against the roll 110 and/or 120 and/or to shorten the stretching gap. Both possibilities lead to a reduction in the neck-in effect and thus to more cost-effective production of a marketable film web. Furthermore, the rollers 144 and/or the clamping roll can be shifted to ultimately avoid marks on the film web 101.

FIG. 5 now shows an advantageous further development of the stretching device according to the invention. Two holding arrangements for two clamping rolls are shown, preferably as shown in FIGS. 2 to 4, wherein one clamping roll is assigned to the line of impact of the film web on the roll and the second clamping roll is assigned to the release line. Both holding arrangements are connected to each other via a connecting element 160. The connecting element offers the advantage that both holding arrangements together with the clamping rolls can be moved relative to the roll 112 by means of a common adjusting device 161. The adjusting device can, for example, comprise a compressed air-operated piston cylinder unit with which the connecting element can be adjusted in the radial direction of the roll 112 (shown by the double arrow 162). For adjustment in the circumferential direction of the roll 112, the connecting element 160 can be arranged displaceable on the adjusting device 161. It is also conceivable that the adjusting device is pivotably arranged on the machine frame or on a bracket supporting the roll 112.

List of reference symbols

| | |
|---|---|
| 100 | Stretching device |
| 101 | Film web |
| 102 | Preheating roller |
| 110 | First roll; holding roll |
| 111 | First clamping roll |
| 112 | Second clamping roll |
| 113 | Holding arrangement |
| 120 | Second roll; stretching roll |
| 121 | Third clamping roll |
| 122 | Fourth clamping roll |
| 130 | Cooling roll |
| 140 | Carrier |
| 141 | Holder |
| 142 | Rotation axis |
| 143 | Axle |
| 144 | Rollers |
| 145 | Magnet |
| 146 | Frame |
| 147 | Rail |
| 148 | Sliding drive for the frame 146 |
| 149 | Double arrow |
| 150 | Attachment pieces |
| 151 | Push rod |
| 152 | Sliding drive for clamping roll 112 |
| 153 | Double arrow |
| 160 | Connecting element |
| 161 | Adjusting device |
| 162 | Double arrow to show the radial direction |
| T | Transport direction |
| R1 | Direction of rotation of the roll 110 |
| R2 | Direction of rotation of the roll 120 |

1. Stretching device for the uniaxial stretching of a film web in its transport direction,
comprising
a first roll (holding roll) over which the film web can be guided and which rotates at a first circumferential speed,
a second roll (stretching roll) arranged downstream of the first roll, over which the film web can be guided and which rotates at a second circumferential speed,
the second circumferential speed being greater than the first circumferential speed,
at least one clamping roll being provided, with which the film web can be pressed against one of the rolls
characterized
in that at least one holding arrangement is provided, relative to which the clamping roll can be rotated about its rotational axis,
in that the clamping roll is supported on the holding arrangement via a support point extending over a part, in particular over more than a quarter, of the axial length of the clamping roll or via a plurality of support points distributed over the axial length of the clamping roll and/or the circumference of the clamping roll, and
in that a first movement device is provided, with which the support point or the support points is or are movable relative to the clamping roll in a direction parallel to the rotational axis of the clamping roll.

2. A stretching device according to claim 1, wherein
the holding arrangement comprises at least one carrier which extends parallel to the rotational axis and is arranged immovably relative to the first and/or second roll.

3. A stretching device according to claim 1, wherein
the first movement device comprises at least one frame on which each support point is supported, the frame being movable relative to the clamping roll and, in particular, relative to the carrier.

4. A stretching device according to claim 1, wherein
the frame is supported on the carrier and, in particular, is displaceable relative to the latter by means of sliding or rolling devices.

5. A stretching device according to claim 1, wherein
the first movement device comprises at least one drive device, with which each support point and in particular the frame is movable alternately in a first direction and in a second direction opposite to the first direction.

6. A stretching device according to claim 1, wherein
a second movement device is provided, with which the clamping roll is movable in its axial direction.

7. Stretching A stretching device according to claim 1, wherein
the clamping roll is connected to the holding arrangement via a holder, wherein in particular the clamping roll is movable relative to the holder with the second movement device or the holder together with the clamping roll is movable relative to the holding arrangement.

8. Stretching A stretching device according to claim 1, wherein
a first row and at least one second row of support points are provided, the rows extending in the longitudinal direction of the clamping roll, in particular the first and second rows being displaceable relative to one another.

9. Method for the uniaxial stretching of a film web in its transport direction
wherein the film web is guided over a first roll (holding roll) which rotates at a first circumferential speed,
wherein the film web is guided over a second roll (stretching roll) which is arranged downstream of the first roll and which rotates at a second circumferential speed,
wherein the second circumferential speed is greater than the first circumferential speed,
wherein the film web is pressed against one of the rolls by at least one clamping roll,
characterized in that at least one holding arrangement is provided, relative to which the clamping roll rotates,
in that the clamping roll is supported on the holding arrangement via a support point extending over a part, in particular over more than a quarter, of the axial length of the clamping roll or via a plurality of support points distributed over the axial length of the clamping roll and/or the circumference of the clamping roll, and
in that the support point or the support points are moved relative to the clamping roll in a direction parallel to the rotational axis of the clamping roll by means of a first movement device.
